(19) United States
(12) Patent Application Publication
(10) Pub. No.: US 2008/0266782 A1
(43) Pub. Date: Oct. 30, 2008

(54) Waterproof keyboard device

(76) Inventor: Qin Zhang, Shanghai City (CN)

Correspondence Address: HARNESS, DICKEY & PIERCE, P.L.C., P.O. BOX 8910, RESTON, VA, 20195, US

(21) Appl. No.: 11/790,765

(22) Filed: Apr. 27, 2007

(51) Int. Cl. G06F 1/16

(52) U.S. Cl. 361/686

(57) ABSTRACT

A keyboard device includes a substrate having top and bottom surfaces, and through holes extending from the top surface to the bottom surface. The bottom surface is formed with an air guide groove unit in fluid communication with each through hole. A sealing layer is mounted sealingly on the bottom surface of the substrate such that the through holes and the air guide groove unit constitute an air passage. A wiring board is mounted on the substrate. When a key cap disposed above a corresponding through hole in the substrate is pressed downwardly, a resilient tubular support member disposed between the key cap and the wiring board deforms such that air in the support member is urged into the air passage.

### BACKGROUND OF THE INVENTION

1. Field of the Invention

The invention relates to a keyboard device, more particularly to a waterproof keyboard device.

2. Description of the Related Art

FIG. 1 illustrates a conventional keyboard device that includes a metal substrate 6, a flexible wiring board 61, a protective layer 66, a visual layer 68, and a plurality of key units 64 (only one is shown). The substrate 6 has a first surface 60, a second surface 67 opposite to the first surface 60, and a plurality of through holes 65 (only one is shown) each extending from the first surface 60 to the second surface 67. The wiring board 61 is mounted on the first surface 60 of the substrate 6, and is provided with a plurality of electrical contacts 63 (only one is shown) thereon registered respectively with the through holes 65 in the substrate 6. The protective layer 66 is mounted on the wiring board 61, and has a plurality of through holes for exposing the electrical contacts 63 therethrough. The visual layer 68 is mounted on the second surface 67 of the substrate 6, but does not cover the through holes 65 in the substrate 6. Each key unit 64 includes a hollow resilient support member 641 that has a lower open end adhered to the protective layer 66, and a key cap 640 retained by a foldable retaining member (not shown) on the support member 641. When the key cap 640 of each of the key units 64 is pressed downwardly to deform the support member 641 such that a conductive pad 642 on the support member 641 of a corresponding one of the key units 64 contacts electrically a corresponding one of the electrical contacts 63 on the wiring board 60, air in the support member 641 of the corresponding one of the key units 64 is expelled via the corresponding one of the through holes 65 in the substrate 6.

In such a configuration, since the visual layer 68 does not cover the through holes 65 in the substrate 6, dust and liquid may get stuck within the through holes 65, thereby hampering smooth operation of the key caps 640.

### SUMMARY OF THE INVENTION

Therefore, the object of the present invention is to provide a keyboard device that can overcome the aforesaid drawback of the prior art.

According to the present invention, a keyboard device comprises:

a substrate having top and bottom surfaces and formed with a plurality of through holes, each of which extends from the top surface to the bottom surface, the bottom surface being formed with an air guide groove unit in fluid communication with each of the through holes;

a sealing layer mounted sealingly on the bottom surface of the substrate for sealing the through holes and the air guide groove unit such that the through holes and the air guide groove unit constitute an air passage between the substrate and the sealing layer;

a wiring board mounted on the top surface of the substrate and provided with a plurality of electrical contacts thereon, each of which is registered with a corresponding one of the through holes in the substrate; and

a plurality of key units, each of which includes
a foldable retaining member attached to the top surface of the substrate and disposed adjacent to a corresponding one of the through holes,
a key cap mounted on the retaining member such that the key cap is movable toward and away from the top surface of the substrate, and
a resilient tubular support member disposed between the key cap and the wiring board and having a closed upper end portion that abuts against the key cap, and an open lower end that is attached sealingly to the wiring board and that is disposed around the corresponding one of the through holes in the substrate, the upper end portion having a bottom surface provided with a conductive pad,
the key cap being operable so as to move between a normal position, where the conductive pad of the resilient support member is spaced apart from a corresponding one of the electrical contacts on the wiring board, and a pressed position, where the key cap is pressed downwardly to deform the resilient tubular support member such that the conductive pad of the resilient tubular support member contacts electrically the corresponding one of the electrical contacts on the wiring board.

When the key cap of each of the key units is switched from the normal position to the pressed position, air in the resilient tubular support member of a corresponding one of the key units is urged into the air passage.

### BRIEF DESCRIPTION OF THE DRAWINGS

Other features and advantages of the present invention will become apparent in the following detailed description of the preferred embodiment with reference to the accompanying drawings, of which:

FIG. 1 is a fragmentary schematic sectional view of a conventional keyboard device;

FIG. 2 is an exploded, fragmentary perspective view showing the preferred embodiment of a keyboard device according to the present invention;

FIG. 3 is a fragmentary schematic sectional view showing the preferred embodiment when a key cap of the preferred embodiment is disposed at a normal position;

FIG. 3a is a fragmentary schematic sectional view showing the preferred embodiment when the key cap of the preferred embodiment is disposed at a pressed position;

FIG. 4 is a fragmentary schematic bottom view showing a sealing layer and a substrate of the preferred embodiment;

FIG. 5 is a fragmentary schematic top view showing an assembly of a wiring board and the substrate of the preferred embodiment; and

FIG. 6 is a fragmentary schematic bottom view illustrating air flowing in an air passage of the preferred embodiment during use.

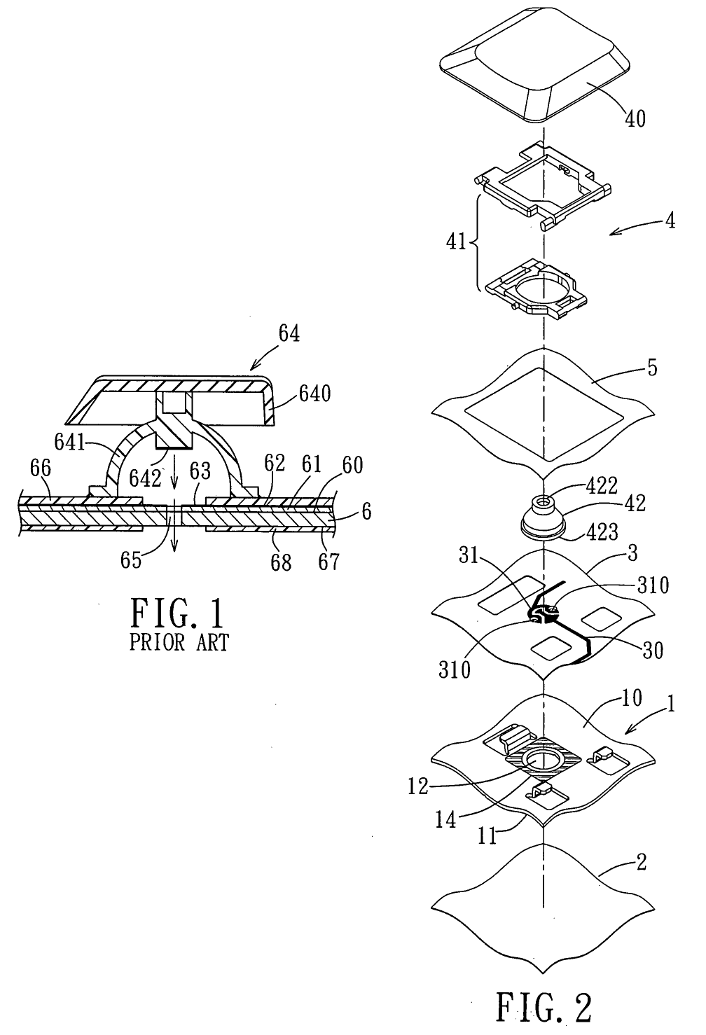

### DETAILED DESCRIPTION OF THE PREFERRED EMBODIMENT

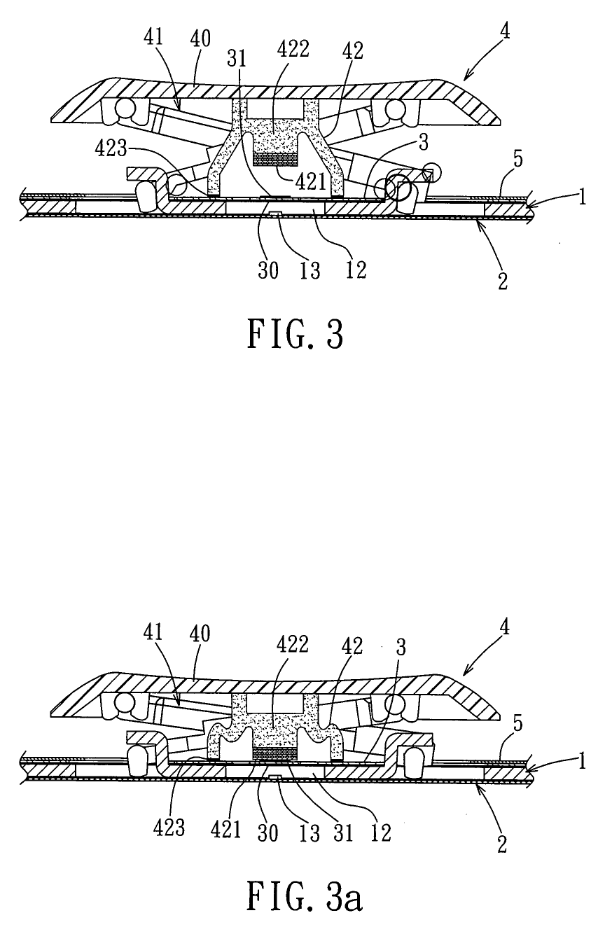

Referring to FIGS. 2 and 3, the preferred embodiment of a keyboard device according to the present invention is shown to include a metal substrate 1, a sealing layer 2, a flexible wiring board 3, a cover layer 5, and a plurality of key units 4 (only one is shown).

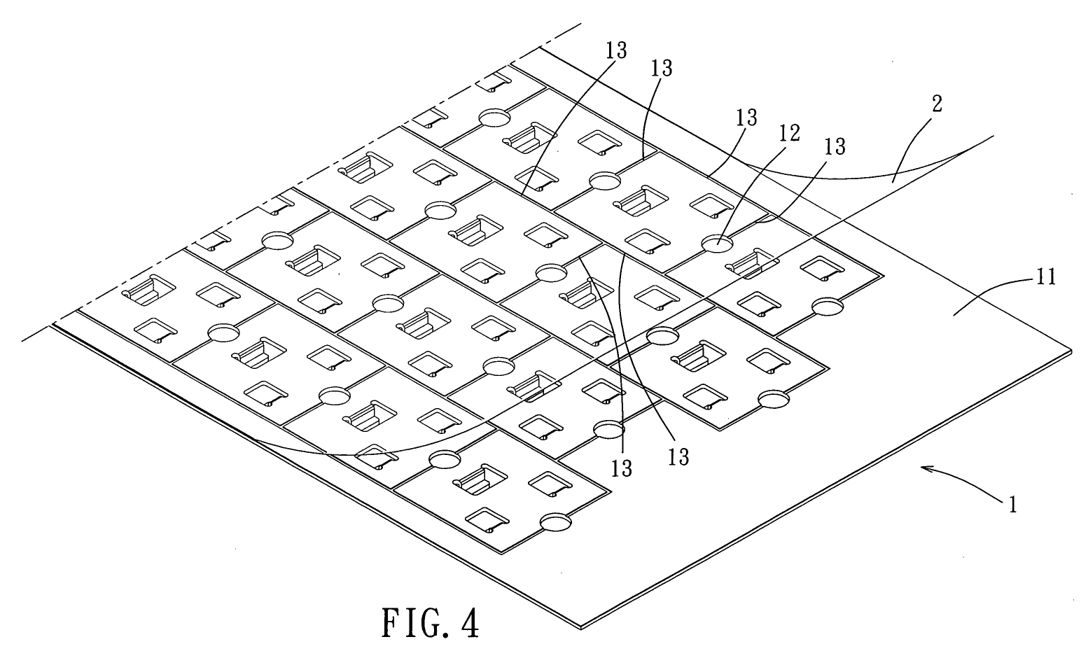

The substrate 1 has top and bottom surfaces 10, 11, and is formed with a plurality of through holes 12, each of which extends from the top surface 10 to the bottom surface 11. The bottom surface 11 is formed with an air guide groove unit in fluid communication with each of the through holes 12. In this embodiment, as shown in FIG. 4, the air guide groove unit includes a plurality of interconnected air guide grooves 13 arranged in the form of grids. Each of the through holes 12 is in fluid communication with a corresponding one of the air guide grooves 13.

Referring further to FIG. 4, the sealing layer 2 is mounted sealingly on the bottom surface 11 of the substrate 1 for sealing the through holes 12 and the air guide grooves 13 in the substrate 1 such that the through holes 12 and the air guide grooves 13 constitute an air passage between the substrate 1 and the sealing layer 2. In this embodiment, the sealing layer 2 is a transparent waterproof film.

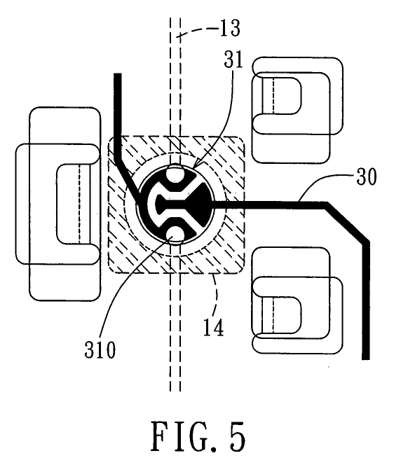

Referring further to FIGS. 3 and 5, the wiring board 3 is mounted on the top surface 10 of the substrate 1, and is provided with a plurality of electrical contacts 31 (only one is shown in FIG. 5), and a printed wiring 30 connected electrically to the electrical contacts 31. Each of the electrical contacts 31 is registered with a corresponding one of the through holes 12 in the substrate 1. In this embodiment, the wiring board 3 is formed with a plurality of air holes 310 (see FIGS. 2 and 5) that are disposed adjacent to each of the electrical contacts 31 and that are in fluid communication with the through holes 12 in the substrate 1, respectively. It is noted that the substrate 1 is further provided with a plurality of adhesive areas 14 (only one is shown in FIG. 2) on the top surface 10, which are disposed respectively around the through holes 12, for adhering sealingly to the wiring board 3, thereby preventing the liquid disposed between the substrate 1 and the wiring board 3 from flowing into the through holes 12.

The cover layer 5 is attached to the wiring board 3 for protection purposes.

Each key unit 4 includes a foldable retaining member 41, a key cap 40 and a resilient tubular support member 42. For each key unit 4, the retaining member 41 is attached to the top surface 10 of the substrate 1 and is disposed adjacent to a corresponding one of the through holes 12. The key cap 40 is mounted on the retaining member 41 such that the key cap 40 is movable toward and away from the top surface 10 of the substrate 1. The support member 42 is disposed between the key cap 40 and the wiring board 3, and has a closed upper end portion 422 that abuts against the key cap 40, and an open lower end 423 that is attached sealingly to the wiring board 3 and that is disposed around the corresponding one of the through holes 12 in the substrate 1. The upper end portion 422 has a bottom surface provided with a conductive pad 421. The key cap 40 is operable so as to move between a normal position, where the conductive pad 421 of the support member 42 is spaced apart from a corresponding one of the electrical contacts 31 on the wiring board 3, as shown in FIG. 3, and a pressed position, where the key cap 40 is pressed downwardly to deform the support member 42 such that the conductive pad 421 of the support member 42 contacts electrically the corresponding one of the electrical contacts 31 on the wiring board 3, as shown in FIG. 3a.

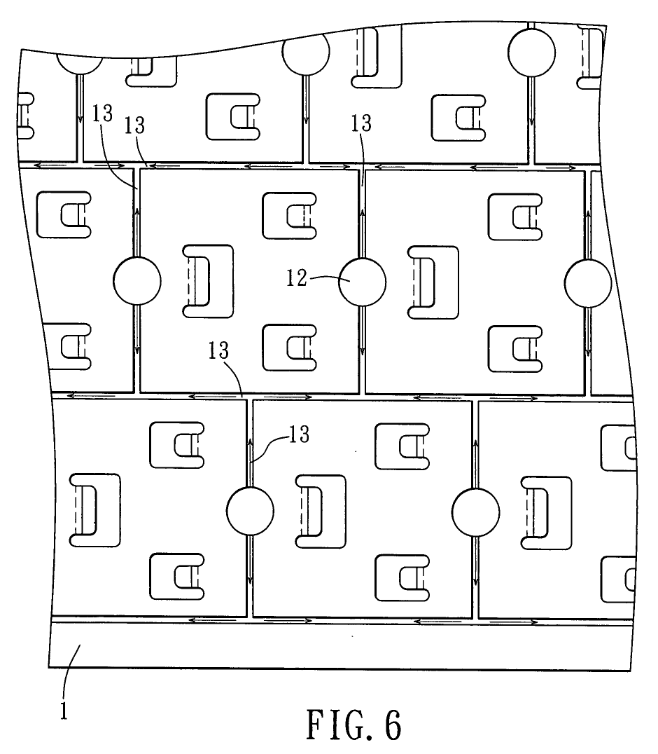

When the key cap 40 of each of the key units 4 is switched from the normal position to the pressed position, air in the support member 42 of a corresponding one of the key units 4 is urged into the air passage, as shown in FIG. 6. It is noted that, due to the presence of the sealing layer 2, entrance of liquid and dust into the air passage can be prevented, thereby ensuring smooth operation of the key caps 40.

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

I claim:

1. A keyboard device comprising:
a substrate having top and bottom surfaces and formed with a plurality of through holes, each of which extends from said top surface to said bottom surface, said bottom surface being formed with an air guide groove unit in fluid communication with each of said through holes;
a sealing layer mounted sealingly on said bottom surface of said substrate for sealing said through holes and said air guide groove unit such that said through holes and said air guide groove unit constitute an air passage between said substrate and said sealing layer;
a wiring board mounted on said top surface of said substrate and provided with a plurality of electrical contacts thereon, each of which is registered with a corresponding one of said through holes in said substrate; and
a plurality of key units, each of which includes
a foldable retaining member attached to said top surface of said substrate and disposed adjacent to a corresponding one of said through holes,
a key cap mounted on said retaining member such that said key cap is movable toward and away from said top surface of said substrate, and
a resilient tubular support member disposed between said key cap and said wiring board and having a closed upper end portion that abuts against said key cap, and an open lower end that is attached sealingly to said wiring board and that is disposed around the corresponding one of said through holes in said substrate, said upper end portion having a bottom surface provided with a conductive pad,
said key cap being operable so as to move between a normal position, where said conductive pad of said resilient tubular support member is spaced apart from a corresponding one of said electrical contacts on said wiring board, and a pressed position, where said key cap is pressed downwardly to deform said resilient tubular support member such that said conductive pad of said resilient tubular support member contacts electrically the corresponding one of said electrical contacts on said wiring board;
whereby, when said key cap of each of said key units is switched from the normal position to the pressed position, air in said resilient tubular support member of a corresponding one of said key units is urged into said air passage.

2. The keyboard device as claimed in claim 1, wherein said sealing layer includes a waterproof film.
